(19) United States
(12) Patent Application Publication
(10) Pub. No.: US 2017/0256095 A1
(43) Pub. Date: Sep. 7, 2017

(54) Blocking screen in Augmented Reality

(71) Applicant: Siemens Medical Solutions USA, Inc., Malvern, PA (US)

(72) Inventor: Ali-Reza Bani-Hashemi, Walnut Creek, CA (US)

(21) Appl. No.: 15/058,806

(22) Filed: Mar. 2, 2016

(51) Int. Cl. G06T 19/00; G02B 27/01

(52) U.S. Cl. CPC G06T 19/006; G02B 27/0172; G02B 27/0101; G02B 2027/0118; G02B 2027/0178

(57) ABSTRACT

To better control the ability to see augmentation in some situations of augmented reality viewing, a blocking screen is positioned to attenuate the brightness from the real scene. The blocking screen programmably attenuates light more in some locations, providing a region where the augmentation information may be better viewed. The amount of attenuation overall or for particular parts of the blocking screen may be altered to account for brightness and/or clutter of the real scene.

### BACKGROUND

The present embodiments relate to augmented reality. In augmented reality, a real-world view is supplemented by a visually integrated or overlaid computer-generated image. A live direct or indirect view of a physical, real-world environment is augmented by the computer-generated image. The reality is enhanced with computer added information, such as text, graphics, avatar, outline, map, or other information. By contrast, virtual reality replaces the real world with a simulated one.

Computer vision (e.g. object recognition and tracking) and tracking devices (e.g. six degrees of freedom accelerometer—gyroscope) have given augmented reality a pleasant immersive user experience. The user may move about the environment, and the augmenting computed-generated graphics appear to be a natural part of or are provided in conjunction with the world.

Despite the better alignment, the combination of augmentation and real view may have problems. Where the real scene is bright, the real scene may overwhelm the augmentation. The augmentation may be difficult to perceive due to the brightness and/or clutter from the real world. Tinted glass may be used to attenuate the light intensity of the real scene, but the tinted glass permanently reduces the light intensity of the background, resulting in problems where the real scene is not as bright.

### BRIEF SUMMARY

By way of introduction, the preferred embodiments described below include methods, systems, instructions, and computer readable media for augmented reality enhancement. To better control the ability to see augmentation in some situations, a blocking screen is positioned to attenuate the brightness from the real scene. The blocking screen programmably attenuates light more in some locations, providing a region where the augmentation information may be better viewed. The amount of attenuation overall or for particular parts of the blocking screen may be altered to account for brightness and/or clutter of the real scene.

In a first aspect, a system is provided for augmented reality. A blocking screen is positioned relative to an augmented reality view device to be between the augmented reality view device and a real scene viewed by the augmented reality view device. A processor is configured to set an amount of blocking of the real scene by the blocking screen to be different for different locations of the blocking screen.

In a second aspect, a method is provided for augmented reality viewing. A screen is set to have variable levels of transparency. Light from a scene is attenuated with the screen where the variable levels of transparency variably attenuate the light. A computer-generated image is combined with the light from the scene.

In a third aspect, an augmented reality system includes a see-through display on which an augmentation image is viewable to a user and through which a real medical scene is viewable to the user, and includes a programmable screen beyond the see-through display relative to the user. The programmable screen is operable to provide a programmable and different relative brightness from the real medical scene and the augmentation image for a first region than for a second region.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 shows an embodiment of an augmented reality system with a blocking screen;

FIG. 2 illustrates one example of a blocking screen positioned relative to an augmented reality view device;

FIG. 3 illustrates another example of a blocking screen positioned relative to an augmented reality view device;

FIG. 4 is an example augmented image with a blocked region; and

FIG. 5 is a flow chart diagram of one embodiment of augmented reality viewing using a blocking screen.

### DETAILED DESCRIPTION OF THE DRAWINGS AND PRESENTLY PREFERRED EMBODIMENTS

Augmented reality projects computer generated images and graphics over the real world scene. It is often desired that the computer-generated images are not merged and combined with the light and images from the real scene to avoid clutter or limiting a viewer's ability to see the augmentation. For example, instructions or drawings are presented to the user as augmentation. It would be desirable for the user to view those augmentations without the interference and clutter caused by the background or real scene. As another example, a patient's vital signals and information are projected as an augmentation while performing medical procedures. To aid in clarity of the patient information, the real scene is attenuated at a location or locations of presentation of the patient information. It would be undesirable for the clinicians to view the information over a bright background image of the real scene.

In general, it is desirable to control the image intensity of the real scene when combined with the computer-generated images (i.e., augmentation). Moreover, it is desirable to dynamically control the ratio by which the augmentation and real images are combined. This dynamic control may be applied to desired sections of the display, in a way that those segments will be viewed with minimum clutter, while viewing the rest of the scene is not affected.

An augmented reality display system is modified to maximize the visibility of the computer-generated imagery. A programmable blocking screen is placed in the optical path of the augmented reality display system. The programmable blocking screen controls a shape of blocking and/or an amount of light attenuation from the real scene. Computer-generated imagery (augmentation) may be viewed clearly without compromising the intensity of the real scene.

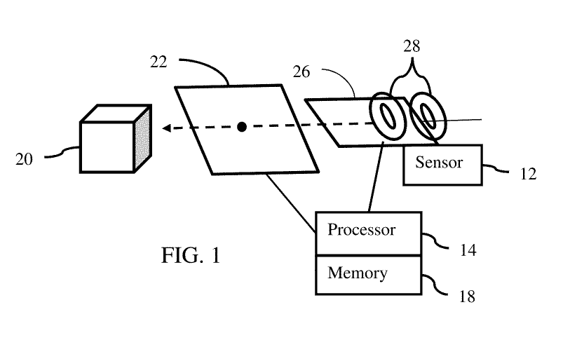

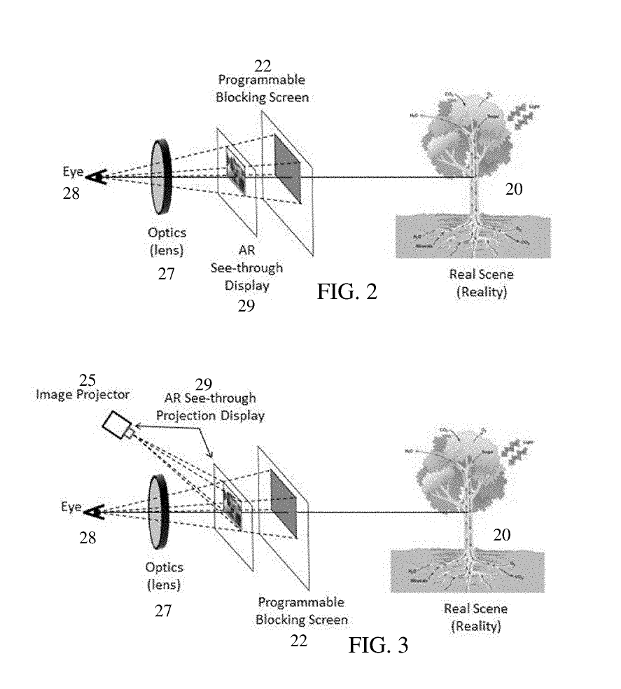

FIG. 1 shows one embodiment of a system for augmented reality. The augmented reality system is modified to selectively attenuate light from the real scene. The selective attenuation provides different opacity for different locations and/or changes the amount of attenuation for different situations. FIGS. 2 and 3 show other embodiments of augmented reality systems.

The system includes a sensor 12, a processor 14, a memory 18, a blocking screen 22, and an augmented reality viewing device 26. Additional, different, or fewer components may be provided. For example, the blocking screen 22 is formed within or as part of the augmented reality viewing device 26. As another example, the sensor 12 is not provided.

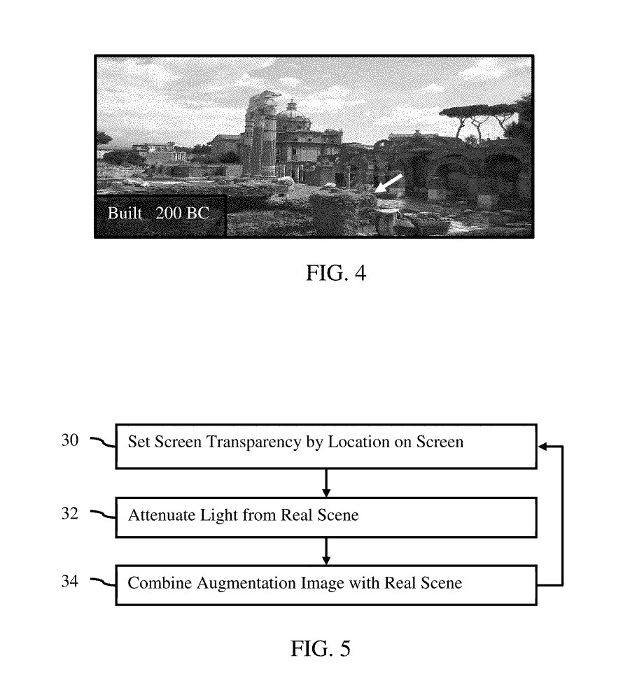

The system implements the method of FIG. 5 or a different method. For example, the processor 14 and blocking screen 22 implement act 30, the blocking screen 22 implements act 32, and the augmented reality viewing device 26 implements act 34. Other components or combinations of components may implement the acts.

In general, the augmented reality viewing device 26 allows a user 28 to view a real scene or object 20. The blocking screen 22 is between the user 28 and the object 20 for altering the contribution of the real scene of the object 20 to the augmented reality view of the user 28.

The augmented reality viewing device 26 is any now known or later developed augmented reality viewing device. For example, the device 26 is any of a head-mounted display, eyewear, heads-up display, or a virtual retinal display. Various technologies may be used in augmented reality rendering including optical projection systems, flat panel displays, or hand-held devices.

As a head-mounted display, a harness or helmet supports a display. An image of the physical world and virtual objects are positioned in the user's field of view. Sensors for measuring position or change in position, such as a gyroscope for measuring in six degrees of freedom, are used to relatively align the virtual information to the physical world being viewed. The perspective of the augmentation adjusts with the user's head movements.

As an eyewear device, cameras may be used to intercept the real-world view. This captured real-world view is displayed with the augmented view on an eyepiece. Alternatively, a see-through surface is provided for viewing the real world without using camera capture. The augmentation image is displayed on the eyepiece through which the real world is viewed, combining the augmentation with the real world. The augmentation image is projected onto, reflected by, or otherwise interacts with the eyepiece.

The head mounted and/or eyewear device may cover the entire field of view of the user. Part of the field of view of the user may be restricted, such as blocking any viewing in peripheral. Alternatively, only part of the field of view is covered by the device. As a heads-up display (e.g., a pair of glasses with a projector), only part of the field of view includes the augmentation. The user may view reality, in part, through part of the lens to which augmentation may not be projected and/or around the edge of the lens.

As a virtual retinal display, the augmentation is scanned or projected directly onto the retina of the viewer's eye. Rather than provide a separate lens or display for the augmented reality, the augmentation image is provided on the user's eye, creating the appearance of a display in front of the user.

The augmented reality viewing device 26 may include one or more of various components. FIGS. 2 and 3 show two examples. FIG. 2 shows one example augmented reality arrangement. The human eye views the computer-generated images on a see-through display 29. The programmable blocking screen 22 behind the see-through display 29 controls the amount of light coming from the real scene. The shape of the block or attenuation region may be controlled by the processor 14 to match the computer-generated augmentation to the user.

FIG. 3 shows another example augmented reality arrangement. The augmented reality viewing device 26 uses a projector 25 for the augmentation. In this case, processor 14 generates the augmentation and causes the projector 25 to project the augmentation onto a see-through reflective surface of the display 29 (e.g., half mirror). In alternative embodiments, the blocking screen 22 is used with a virtual retinal display system or another type of augmented reality viewing device.

A source of the augmentation is provided, such as a processor 14. The source may include a display device for displaying the augmentation, such as a see-through screen 29, lens, and/or the surface of the eye. A projector 25, light source, laser, or other device transmits the augmentation to the display or retina. Alternatively, the display device creates the augmentation image, such as a transparent display creating the augmentation to be viewed by the user.

Other components may be provided in the augmented reality viewing device 26. For example, one or more cameras (e.g., one camera for each eye) are used to capture the real scene, which is then projected or otherwise reproduced on the display 29 rather than using a see-through display. As another example, an eye tracker (e.g., camera directed at the user's eye) is used to align the augmentation perspective with the direction of the user's focus. In yet another example, a lens 27 (FIGS. 2 and 3) is provided as or separate from the see-through display 29.

In one embodiment, the augmented reality viewing device is worn by a medical professional or another person in a medical environment. Medical instruments, medical equipment, and/or a patient are viewed as part of the real scene. The user views the real scene through the see-through display 29 on which an augmentation image is also viewable. Alternatively, the user views a display on which the real scene and the augmentation are presented. For example, patient vitals (e.g., heart rate and/or temperature), scan (e.g., x-ray view of the interior of the patient), or other patient information (e.g., name, sex, or surgical plan) are provided as an augmentation. While the physician views the patient, the augmentation is also provided. As another example, a technician views a medical scanner or other medical equipment. Information about the equipment being viewed (e.g., part number, failure rate, cleaning protocol, or testing process) is provided as the augmentation. In alternative embodiments, the augmented reality viewing device 26 is used in other environments than the medical environment.

The blocking screen 22 is a transparent display. For example, the blocking screen 22 is a transparent liquid crystal display. As another example, the blocking screen 22 is an organic light emitting diode screen. The real scene (e.g., patient in a medical environment) may be viewed through the transparent display.

The blocking screen 22 is a separate device than the see-through display 29. Alternatively, the blocking screen 22 is incorporated as a separate layer or layers of the see-through display 29. In another alternative, the see-through display 29 also forms the blocking screen 22. Both blocking and display are provided at the same time by a same device.

The blocking screen 22 is positioned relative to the augmented reality view device 26 to be between the augmented reality view device 26 and a real scene viewed through the augmented reality view device 26. The blocking screen 22 is beyond the see-through display 29 relative to the user. For example, the blocking screen 22 is stacked along the viewing direction with the display 29 of the augmented reality view device 26. The blocking screen 22 is in the optical path of real scene and not the augmentation for the augmented reality view device 26.

Any amount of spacing of the blocking screen 22 from the display 29 and/or augmented reality viewing device 26 may be provided. For example, spacing less than an inch (e.g., 1 mm) is provided. Greater spacing may be used, such as being closer to the object 20 than to the display 29 or augmented reality viewing device 26. The spacing may be zero where the see-through display 29 and blocking screen 22 are a same device.

The blocking screen 22 is parallel to the display 29. Where the display 29 curves, the blocking screen 22 has a same curvature. Alternatively, different curvature and/or non-parallel arrangements are used.

The blocking screen 22 has a same or different area as the display 29. For example, the blocking screen 22 has a larger area to account for being farther from the viewer 28 so that the entire display 29 as viewed by the viewer 28 is covered by the blocking screen 22. In another example, the blocking screen has a smaller area, such as covering less than half of the display 29.

A housing, armature, spacer, or other structure connects the blocking screen 22 with the display 29 and/or the augmented reality viewing device 26. For example, a housing connects with both the display 29 and the blocking screen 22, holding them fixedly in place relative to each other. The connection is fixed or releasable. The blocking screen 22 may be released from the augmented reality viewing device 26. In other embodiments, the connection is adjustable, allowing the blocking screen 22 to move relative to the display 29. Alternatively, the blocking screen 22 is separately supported and/or not connected to the augmented reality viewing device 26 and/or the display 29.

The blocking screen 22 is programmable. The blocking screen 22 is under computer, controller, or processor 14 control. One or more characteristics of the blocking screen 22 are controlled electronically. Any characteristics may be programmed, such as an amount or level of transparency. Each pixel or location on the blocking screen 22 has a programmable transparency over any range, such as from substantially transparent (e.g., transparent such that the user does not perceive the screen 22 other than grime, smudges, or other effects from normal wear of glasses along a line of focus) to substantially opaque (e.g., less than 10% visibility through the screen 22).

Due to the programming, the relative brightness from the real scene (e.g., from a medical object 20 being viewed) to the augmentation may be affected. By reducing transparency and/or opacity, the contribution of the brightness from the real scene may be selected and established by the blocking screen 20.

Different pixels or locations on the blocking screen 22 may be programmable to provide different levels of attenuation. For example, one region is made more opaque than another region. As another example, different patterns of different amounts of transparency are used to effect an overall level of transparency. In yet another example, a transitional region of a linear or non-linear variation in transparency is set.

In the medical environment example, one region of the blocking screen 22 is more opaque than the rest of the blocking screen 22 so that lesser brightness from the real medical scene passes through the blocking screen 22 at that region. Normally, the blocking screen 22 is transparent, which allows the user to view the computer-generated images and the real scene. The programmable blocking screen 22 is made more opaque in one region when it is desired to block or reduce contribution from a portion of the real scene, so the computer-generated images are viewed with greater clarity without being mixed with the light or with being mixed with less light from the real scene.

The sensor 12 is a brightness sensor. The sensor 12 may be diode based or an ambient light sensor. The sensor 12 may have multiple functions, such as being a camera to capture the real world scene for re-display as well as a light level. By sensing the ambient light or brightness of the real scene with the sensor 12, the processor 14 may control the average, base line, or other level of transparency. As a result, the blocking screen 22 may be used to reduce brightness across the entire or some parts of the screen 22 where the real scene is bright (e.g., outside in full sun or in a medical environment lit for surgery). When the same augmented reality system is in a darker environment, the processor 14 causes the entire screen 22 or parts of the screen 22 to be more transparent.

The processor 14 and/or memory 18 are part of the augmented reality viewing device 26. The processor 14 and/or memory 18 are included in a same housing with the display 29 or are in a separate housing. In a separate housing, the processor 14 and/or memory 18 are wearable by the user, such as in a backpack, belt mounted, or strapped on arrangement. Alternatively, the processor 14 and/or memory 18 are spaced from a user as a computer, server, workstation, or other processing device using communications with the display 29 and/or blocking screen 22. Wired or wireless communications are used to interact between the processor 14, the memory 18, the blocking screen 22, the sensor 12, the display 29, and any other controlled electrical component of the augmented reality viewing device 26 (e.g., a projector). Separate processors may be used for any of the components.

The processor 14 is a general processor, central processing unit, control processor, graphics processor, digital signal processor, three-dimensional rendering processor, image processor, application specific integrated circuit, field programmable gate array, digital circuit, analog circuit, combinations thereof, or other now known or later developed device. The processor 14 is a single device or multiple devices operating in serial, parallel, or separately. The processor 14 may be a main processor of a computer, such as a laptop or desktop computer, or may be a processor for handling some tasks in a larger system, such as in the augmented reality viewing device 26. The processor 14 is configured by instructions, design, firmware, hardware, and/or software to perform the acts discussed herein.

The processor 14 is configured to generate an augmentation. An avatar, text, graphic, chart, illustration, overlay, image, or other information is generated by graphics processing and/or loading from memory 18. The augmentation is information not existing in the viewed real scene and/or information existing but altered (e.g., added highlighting).

The processor 14 is configured to align the augmentation with the real scene. Information from sensors is used to align. Alternatively, the augmentation is added to the user's view regardless of any alignment with the real scene.

The augmentation has any position in the user's view. The processor 14 causes the display 29 to add the augmentation to the user's view. The augmentation has any size, such as being an overlay for the entire view. In one embodiment, the augmentation includes some information in a sub-region, such as a block area along an edge (e.g., center, left, or right bottom). For example, patient information (e.g., vitals, surgical plan, medical image, and/or medical reminders) is provided in a sub-region of the user's view and/or the display 29. The positioning of the sub-region avoids interfering with or cluttering the object 20 of interest (e.g., a part of the patient) but allows the user to shift focus to benefit from the augmentation. As another example, the augmentation is placed to be viewed adjacent to corresponding parts of the object 20 or real scene, such as annotations positioned in small sub-regions on or by different parts of the object 20 (e.g., labeling suspicious locations in an organ being viewed by the user).

To avoid clutter for the augmentation, the blocking screen 22 is configured by the processor 14 to control a light level from the real scene. For locations of annotation, the augmentation sub-region, or other locations, the processor 14 controls the blocking screen 22 to reduce or block the real scene, leaving just the augmentation or leaving the augmentation with less light from the real scene for those locations. Any size and shape of the blocking sub-region may be used. The blocking or light reduction may be for the entire augmentation or just one or more parts of the augmentation (e.g., blocking for sub-region, but not attenuating for outlines, highlighting, or other locations of the augmentation). Other locations are blocked differently than the sub-region.

The processor 14 is configured to set an amount of blocking of the real scene by the blocking screen 22. The amount is set to be different for different locations of the blocking screen 22. By establishing the transparency for each pixel, the amount of blocking per location is set.

FIG. 4 shows an example. The real scene is of ruins. The augmentation includes text indicating when a particular ruin was constructed and an arrow pointing to the ruin. To better see the text of when the ruin was constructed, the blocking screen 22 is controlled to block the real scene with a black region (other colors may be used), and part of the augmentation is placed within that region. The blocking region is 50% transparent, but may be more or less transparent. The blocking screen 22 does not block at all or as much where the arrow is located or anywhere else in the display 29. The blocking screen 22 may block different locations of the real scene by different amounts.

In one embodiment, the processor 14 configures the blocking screen 22 to block the real scene for a sub-region of the viewable display 29. Any level of blocking may be used, such as fully opaque or partially transparent. The other parts of the viewable area are blocked less or more by the blocking screen 22. For example, the amount of blocking is higher for a location of text as viewed by the user of the augmented reality view device 26 and lesser for locations spaced from the text as viewed by the user (see FIG. 4 for an example where the blocking screen 22 creates the rectangular area on which the augmentation text is displayed).

Any area of the blocking screen 22 may be programmed to block the incoming light from the real scene. When viewed by the user's eye, the shape and size of the blocking area is programmable to coincide with the computer-generated images. The attenuation factor (e.g., level of attenuation or transparency) of the blocking screen's 22 sub-region is also fully programmable. That way, it is possible to combine the brightness of the computer-generated images (e.g., augmentation) and the real scene individually. The blocking screen 22 controls the brightness of the real scene, while the projector 25 or display 29 controls the brightness of the augmenting images.

The processor 14 controls the transparency, such as controlling light emissions and the color of the emissions. For transparent, the pixels are not activated. For opaque, the pixels are activated fully in a color. For attenuation of light in-between opaque and transparent, the pixels are activated partially or less brightly. By altering the opacity of the pixels of the blocking screen 22, the processor 14 sets the amount of blocking or attenuation by location. Different locations may be set to have different level or amount of blocking.

The amount of blocking for the entire blocking screen 22 or parts (e.g., sub-region) may be a function of brightness of the real scene. For brighter environments, the blocking screen 22 may be set to attenuate the light from the real scene more, acting as tinted glass to reduce the brightness as viewed by the user. For darker environments, the blocking screen 22 may be set to attenuate the light less (i.e., more transparent). In one embodiment, the attenuation is different at different locations, but with a base attenuation for the entire screen 22 being based on the sensed brightness. The sub-region is set to have more attenuation than the base attenuation. The brightness sensor 12 is used to determine the base level of attenuation.

The memory 18 is a graphics processing memory, video random access memory, random access memory, system memory, cache memory, hard drive, optical media, magnetic media, flash drive, buffer, database, combinations thereof, or other now known or later developed memory device for storing augmentation images, blocking pattern, control information, sensor measures, camera images, and/or other information. The memory 18 is part of a computer associated with the processor 14, the augmented reality viewing device 26, or a standalone device.

The memory 18 or other memory is alternatively or additionally a computer readable storage medium storing data representing instructions executable by the programmed processor 14 or other processor. The instructions for implementing the processes, methods, acts, and/or techniques discussed herein are provided on non-transitory computer-readable storage media or memories, such as a cache, buffer, RAM, removable media, hard drive, or other computer readable storage media. Non-transitory computer readable storage media include various types of volatile and nonvolatile storage media. The functions, acts or tasks illustrated in the figures or described herein are executed in response to one or more sets of instructions stored in or on computer readable storage media. The functions, acts, or tasks are independent of the particular type of instructions set, storage media, processor or processing strategy and may be performed by software, hardware, integrated circuits, firmware, micro code and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

FIG. 5 shows a method for augmented reality viewing. In general, the method is directed to controlling the contribution of the real scene in augmented reality. The contribution of the real scene may be controlled differently for different locations visible by the viewer using a blocking screen.

The method is performed by the system of FIG. 1, the system of FIG. 2, the system of FIG. 3, a processor, a medical imaging system, an augmented reality viewing device, or combinations thereof. For example, a processor performs act 30 using a blocking screen 22, the blocking screen 22 performs act 32, and the augmented reality viewing device performs act 34.

The method is performed in the order shown or a different order. Additional, different, or fewer acts may be provided. For example, acts for generating the augmentation, acts for aligning (e.g., position, orientation, and/or scale) the augmentation with the real scene, and/or other augmented reality acts are provided. Acts for calibrating the blocking screen and/or augmented reality viewing device may be provided.

In act 30, a screen is configured to have variable levels of transparency. A controller sets the levels of different locations. For example, a sub-region of a liquid crystal display is programmed to be more opaque than other parts of the liquid crystal display. Any grouping or pattern of variation in transparency at a given time may be used.

The levels may be maximally transparent as a default. Maximally accounts for the most transparent a given screen is capable. Other defaults may be used. One or more other locations are made more opaque, up to a maximally opaque level.

The levels are set based on any consideration, such as the importance or desired focus to be provided for an augmentation. For example, the locations of important augmentation or augmentation relying less on reference to specific objects the real scene are made more opaque. Other criteria may be used to determine which locations to make more opaque.

The setting of the level of transparency may be based on a light level of the scene. For greater light levels, levels that are more opaque are used. The regions to be blocked are more opaque to account for the greater brightness of the scene. Alternatively, the entire screen is set to attenuate more for brighter light in the real scene with or without sub-regions being even more attenuating.

In act 32, the screen attenuates light from a scene. To view the scene, light from the scene follows paths to the viewer. The screen intervenes as the screen is positioned between the object being viewed and the augmented reality viewing device or display. The light passing through different locations on the screen is attenuated by the levels of transparency for the locations. For example, the light passing through one region is attenuated more than the light passing through the rest of the screen. The variable levels of transparency variably attenuate the light. The screen attenuates the light of the reality component of the augmented reality viewing.

In act 34, the augmented reality viewing device combines a computer-generated image with the light from the scene. The combination is made by adding the computer-generated image to the scene. The augmentation is added by reflection, projection, or other process. The viewer perceives both the augmentation and the scene. The combination provides the augmentation on or in conjunction with the scene.

The augmentation is provided in a specific location or locations in the viewing area or relative to at least a portion of the scene as viewed by the user. The augmentation may be aligned (e.g. position and/or scale) with the scene. Alternatively, the augmentation is placed in a particular location on a display of the scene regardless of the current view of the scene. In either case, the viewer using the augmented reality viewing device sees the computer-generated image in a sub-region of the scene. That sub-region is more opaque than other parts of the scene due to the attenuation. As a result, the augmentation at that sub-region may be more visible to the viewer in the combination. Other parts of the augmentation may be displayed at locations with less attenuation, resulting in greater relative contribution from the light of the scene.

In one embodiment, the computer-generate image is an augmentation of a scene in a medical environment. For example, light from the scene of a patient and/or medical equipment is combined with medical information augmenting the scene. The medical information is for the patient and/or the medical equipment. At least some of the medical information augments at a location relative to the screen that is less transparent. The medical information is presented on the more opaque region to avoid clutter or overwhelming by the scene. The medical information may be more easily viewed and/or comprehended due to the screen limiting the level of light from the scene at the location as viewed by the user.

A feedback loop is shown from act 34 to act 30. This feedback represents changing the setting of the transparency at a later time. As the viewer changes their view, the location of the augmentation may change. The blocking by the screen changes according to the position of the augmentation. Alternatively or additionally, the augmentation may change over time, such as annotating a different object in the scene. Due to the change in the augmentation, the position of blocking by the screen changes.

Because of the change, a given location may have different transparency at different times. A location may be blocked or more highly attenuating for a first time and then not blocked or more transparent for another time. The level of attenuation may or may not change for each location.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A system for augmented reality, the system comprising:
an augmented reality view device;
a blocking screen positioned relative to the augmented reality view device so as to be between the augmented reality view device and a real scene viewed by the augmented reality view device; and
a processor configured to set an amount of blocking of the real scene by the blocking screen to be different for different locations of the blocking screen.

2. The system of claim 1 wherein the augmented reality view device comprises a head-mounted display, eyewear, heads-up display, or a virtual retinal display.

3. The system of claim 1 wherein the blocking screen comprises a transparent display.

4. The system of claim 1 wherein the blocking screen comprises a transparent liquid crystal display.

5. The system of claim 1 wherein the blocking screen is stacked along a viewing direction with a display of the augmented reality view device.

6. The system of claim 1 wherein the blocking screen comprises a see-through display of the augmented reality view device.

7. The system of claim 1 wherein the processor is configured to set the amount by altering opacity of the blocking screen.

8. The system of claim 1 wherein the processor is configured to set the amount higher for a location of text as viewed by a user of the augmented reality view device and lesser for a location spaced from the text as viewed by the user.

9. The system of claim 1 wherein the processor is configured to generate an augmentation of patient information in a sub-region of view of the augmented reality view device and to block the real scene with the blocking screen for the sub-region.

10. The system of claim 1 wherein the processor is configured to set the amount of the blocking of the real scene in response to a brightness sensor, with the amount being greater for a sub-region of view of the augmented reality view device.

11. The system of claim 1 wherein the blocking screen, as configured by the processor, is operable to control a light level from the real scene.

12. A method for augmented reality viewing, the method comprising:
setting a screen to have variable levels of transparency;
attenuating light from a scene with the screen where the variable levels of transparency variably attenuate the light; and
combining a computer-generated image with the light from the scene.

13. The method of claim 12 wherein setting the screen comprises programming a first sub-region of a liquid crystal display to be more opaque than a second sub-region, and wherein combining comprises including at least a part of the computer generated image in the first sub-region as viewed by a viewer of an augmented reality viewing device.

14. The method of claim 12 wherein combining comprises combining the computer-generated image as an augmentation of a scene, and wherein attenuating the light from the scene comprises attenuating a reality component of the augmented reality viewing.

15. The method of claim 12 wherein attenuating comprises positioning the screen between a viewer and an augmented reality viewing device.

16. The method of claim 12 wherein setting comprises setting based on a light level of the scene.

17. The method of claim 12 wherein combining comprises combining the light from the scene being from a patient and the computer-generated image being medical information for the patient, the medical information being at a location relative to the screen that is less transparent.

18. The method of claim 12 further comprising resetting the levels of transparency of the screen such that a first location is more or less transparent.

19. An augmented reality system comprising:
a see-through display on which an augmentation image is viewable to a user and through which a real medical scene is viewable to the user; and
a programmable screen beyond the see-through display relative to the user, the programmable screen operable to provide a programmable and different relative brightness from the real medical scene and the augmentation image for a first region than for a second region.

20. The augmented reality system of claim 19 wherein the programmable screen comprises a liquid crystal display through which the real medical scene is viewable where the augmentation image comprises medical information positioned in the first region, the first region having a lesser brightness from the real medical scene due to the programmable screen being more opaque in the first region.
